(19) United States
(12) Patent Application Publication
(10) Pub. No.: US 2024/0267086 A1
(43) Pub. Date: Aug. 8, 2024

(54) WIRELESS POWER-SUPPLY COMMUNICATION SYSTEM

(71) Applicant: SMK Corporation, Tokyo (JP)

(72) Inventor: Toshio HAIJIMA, Kanagawa (JP)

(21) Appl. No.: 18/424,836

(22) Filed: Jan. 28, 2024

(30) Foreign Application Priority Data
Feb. 2, 2023 (JP) 2023-014755

(51) Int. Cl. H04B 5/79; H04B 5/73; H04B 5/77

(52) U.S. Cl. CPC H04B 5/79; H04B 5/73; H04B 5/77

(57) ABSTRACT

The wireless power-supply communication system includes a beacon device having a WPT power receiver and a battery chargeable via the WPT power receiver and configured to output information in every lapse of a preset standby period, and a power-transmission reception apparatus incorporated into or communicably connected to a host terminal and configured to wirelessly transfer power to the device and receive the information transmitted from the device. A wireless communication unit on the power-transmission reception apparatus side has a power-transmission reception side MCU that fluctuates the wireless power transfer to the device side, and a wireless communication unit on the device side has a power-reception transmission side MCU that determines fluctuation in the wireless power transfer and controls the device to perform predetermined operation according to a determination result.

The contents of the following Japanese patent application(s) are incorporated herein by reference:
NO. 2023-014755 filed in JP on Feb. 2, 2023.

### FIELD

The present invention relates to a wireless power-supply communication system, and particularly relates to a wireless power-supply communication system that receives, by a power-transmission reception side device, information output in every lapse of a preset standby period from a power reception side information output device.

### BACKGROUND

Typically, there has been known a wireless power-supply communication system such as an Internet-of-Things (IoT) sensor communication system including a beacon device that transmits information at certain time intervals and receives power wirelessly supplied by wireless power transfer and a power-transmission receiver that performs the wireless power transfer (wireless power supply) to the beacon device and receives information data from the beacon device.

In such a communication system allowing the wireless power supply, the beacon device is operated by a power storage means such as a secondary battery or a capacitor, and therefore, in many of these systems, the beacon device is activated at predetermined time intervals to transmit data to the power-transmission receiver in order to reduce power consumption and reduce the amount of power supplied by the wireless power supply.

As the typical communication system of this type, there has been, for example, a wireless power supply apparatus including a detection means that detects a power reception apparatus within an area where power can be transmitted by intermittent transmission of detection power and a power transmission means that wirelessly transmits power greater than the detection power to the power reception apparatus detected by the detection means. In the wireless power supply apparatus, an authentication means that authenticates the power reception apparatus detected by the detection means is provided, and the power transmission means wirelessly transmits the power only to the successfully-authenticated power reception apparatus so that unnecessary wireless power transfer processing can be reduced (see, e.g., Patent Literature 1).

### PRIOR ART DOCUMENT

### Patent Literature

Patent Literature 1: JP-A-2016-111879

### SUMMARY

However, in the above-described typical wireless power-supply communication system, a power reception side information output device such as the beacon device is constantly in a sleep state (e.g., low power consumption state in which only a timer is set) during a period other than an information output period for transmitting data in order to reduce power consumption. For this reason, the power reception side information output device cannot receive communication from the power-transmission receiver side under the sleep (Sleep) state.

Thus, the power reception side information output device cannot respond to communication at arbitrary timing in a case where the power-transmission receiver starts such communication, and the power-transmission receiver cannot request, as needed, the power reception side information output device to promptly output information or to change an information output condition.

Specifically, the typical power reception side information output device such as the beacon device is normally mostly in the sleep state even under a fully-charged state. The power reception side information output device is operated only at the time of data transmission, and in a case of opening a reception window, opens the reception window for a response immediately after transmission. For this reason, a command can be received only immediately after the data transmission timing. For example, in a case of an IoT device, the number of times of transmission of which is small such as once a day, the IoT device has system disadvantages that the IoT device is normally mostly in a sleep state, has an opportunity to communicate a command only once a day, and cannot promptly transmit data or communicate a command.

An aspect of the present invention has been made in order to solve the above-described typical problems, and is intended to provide a wireless power-supply communication system configured so that a power reception side information output device can be activated, using wireless power transfer itself from a power-transmission reception side device, at arbitrary timing from the power-transmission reception side device.

The wireless power-supply communication system according to an aspect of the present invention is, in order to achieve the above-described object, (1) a wireless power-supply communication system including an information output device having a power reception circuit that receives power by wireless power transfer and a power storage means chargeable via the power reception circuit and configured to output information in every lapse of a preset standby period, and a power-transmission reception side device incorporated into or communicably connected to a host terminal and configured to wirelessly transfer power to the information output device and receive the information from the information output device. The host terminal or the power-transmission reception side device has a power-transmission reception side controller that fluctuates the wireless power transfer to the information output device, and the information output device has a power-reception transmission side controller that determines fluctuation in the wireless power transfer and controls the information output device to perform predetermined operation according to a fluctuation determination result.

With this configuration, in an aspect of the present invention, the power-transmission reception side controller fluctuates the wireless power transfer to the information output device so that a signal requesting the predetermined operation can be transmitted to the power reception side information output device according to such fluctuation. The information output device causes the power-reception transmission side controller to implement the wireless power transfer fluctuation determination function when the wireless power transfer fluctuates in a specific pattern, so that the predetermined operation requested by such fluctuation can be determined. Thus, the wireless power-supply communication system can be provided, which is configured so that the power reception side information output device can be activated, using the wireless power transfer itself from the power-transmission reception side device for signal transmission, at arbitrary timing from the power-transmission reception side device.

Note that the standby period described herein is a period having a certain time length, but may be a period having a time length changed according to an environmental condition such as a temperature. The power-transmission reception side controller may convert power into an alternating frequency with a transmission band for the wireless power transfer (wireless power transmission) to output an electromagnetic wave receivable by the information output device via a power transmission antenna. On the other hand, the power-reception transmission side controller may generate alternating-current power by the power reception circuit resonating with the electromagnetic wave received via an antenna, and may rectify the alternating-current power into direct current or alternating-current power with a desired frequency.

(2) In an embodiment of an aspect of the present invention, the power-transmission reception side controller may intermittently perform the wireless power transfer from the power-transmission reception side device to the information output device in a predetermined fluctuation pattern. In this case, the wireless power transfer is intermittently performed in a predetermined intermittent pattern, and according to the intermittent pattern, the information output device determines the fluctuation pattern at the time of wireless power reception so that the power reception side information output device can be easily activated.

(3) In an embodiment of an aspect of the present invention, the power-reception transmission side controller may open a reception window according to the fluctuation determination result, and may control the information output device to perform the predetermined operation according to a command received from the power-transmission reception side device while the reception window is opened. In this case, regardless of preset time or elapsed time, the predetermined operation can be executed according to the command from the power-transmission reception side device at a timing of receiving the command by the power-reception transmission side controller.

(4) In an embodiment of an aspect of the present invention, the information output device may be a beacon device that transmits information by wireless communication in every lapse of the preset standby period. With this configuration, a device that performs power-saving near field communication can be promptly activated as necessary while being used with power saved because the device can be sufficiently in a standby state.

(5) In an embodiment of an aspect of the present invention, the information output device may have an IoT sensor. In this case, the sensor information can be promptly output as necessary even if extremely-low power consumption is required and the standby period is long. The IoT sensor described herein is, for example, a sensor device such as a temperature sensor, a humidity sensor, an acceleration sensor, or a noise sensor.

(6) In an embodiment of an aspect of the present invention, the information output device may output the information with output data in an advertising communication packet in predetermined power-saving near field communication. With this configuration, the data can be output from the information output device to the power-transmission reception side device before establishment of connection by pairing and the power required for information output repeated in every lapse of the standby time can be sufficiently reduced.

A wireless power-supply communication method according to an aspect of the present invention is, in order to achieve the above-described object, (7) a wireless power-supply communication method including a power storage step of storing power in a power storage means via a power reception circuit that receives the power by wireless power transfer, an information output step of outputting, with the stored power, information from a power reception side information output device in every lapse of a preset standby period, a power supply step of wirelessly transferring power to the information output device by a power-transmission reception side device incorporated into or communicably connected to a host terminal, and a reception step of receiving the information output from the information output device by the power-transmission reception side device. The wireless power-supply communication method further includes a power transmission control step of fluctuating the wireless power transfer to the information output device by the host terminal or the power-transmission reception side device, and an information transmission control step of determining fluctuation in the wireless power transfer by the information output device and executing predetermined operation related to information output by the information output device according to a fluctuation determination result.

With this configuration, in the method of an aspect of the present invention, the wireless power transfer to the information output device is fluctuated by the power supply step from the power-transmission reception side device to the power reception side information output device, so that the predetermined operation can be requested to the information output device according to such fluctuation. Moreover, in a case where the wireless power transfer fluctuates in a specific pattern, the information output device can be activated and the predetermined operation requested by such fluctuation can be determined. Thus, the wireless power-supply communication method can be provided, in which the power reception side information output device can be activated, using the wireless power transfer from the power-transmission reception side device, at arbitrary timing from the power-transmission reception side device.

According to an aspect of the present invention, the wireless power-supply communication system can be provided, which is configured so that the power reception side information output device can be activated, using the wireless power transfer from the power-transmission reception side device, at arbitrary timing from the power-transmission reception side device.

### BRIEF DESCRIPTION OF DRAWINGS

FIG. 1 is a schematic configuration diagram of a wireless power-supply communication system according to one embodiment of an aspect of the present invention.

FIG. 2 is a functional block configuration diagram of a beacon device in the wireless power-supply communication system of one embodiment of an aspect of the present invention.

FIG. 3 is a sequence chart showing an outline communication procedure in the wireless power-supply communication system of one embodiment of an aspect of the present invention.

FIG. 4 is a flowchart showing an outline control procedure in a power reception side information output device in the wireless power-supply communication system of one embodiment of an aspect of the present invention.

### DESCRIPTION OF EMBODIMENTS

Hereinafter, embodiments of an aspect of the present invention will be described with reference to the drawings.

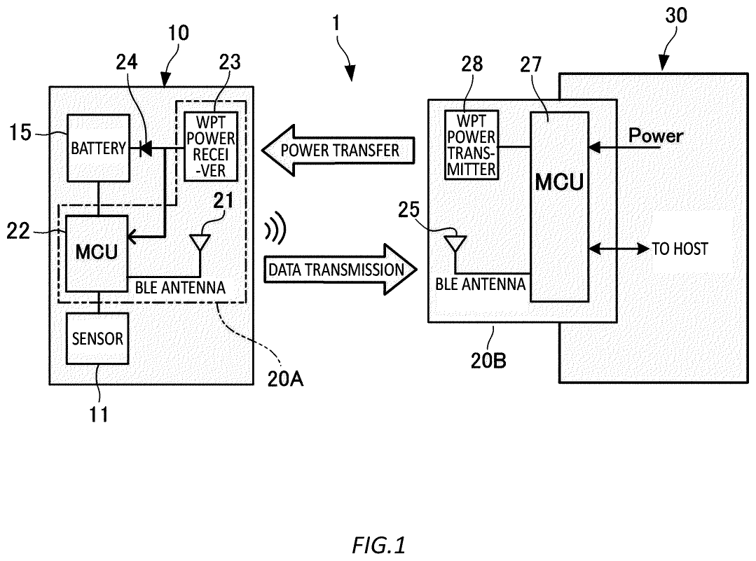

FIGS. 1 to 4 show the configuration of a wireless power-supply communication system according to one embodiment of an aspect of the present invention and the outline of the flow of operation of the wireless power-supply communication system.

First, the configuration will be described.

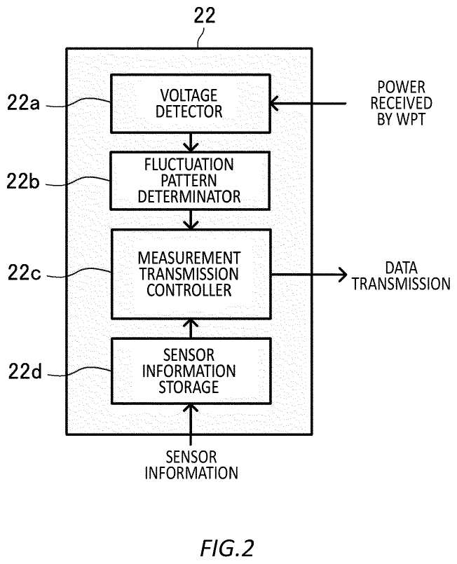

As shown in FIGS. 1 and 2, a wireless power-supply communication system 1 according to one embodiment of an aspect of the present invention includes at least one beacon device 10 which is a power reception side information output device, at least one power-transmission reception apparatus 30 that wirelessly transfers power to the beacon device 10 and receives information data-transmitted from the beacon device 10, and a power-reception transmission side wireless communication unit 20A and a power-transmission reception side wireless communication unit 20B built in or incorporated into the beacon device 10 and the power-transmission reception apparatus 30 such that predetermined power-saving near field communication, such as near field communication (hereinafter also merely referred to as BLE communication) in accordance with Bluetooth Low Energy (registered trademark) standards, is executed between the beacon device 10 and the power-transmission reception apparatus 30.

As shown in FIG. 1, the beacon device 10 has a sensor 11 capable of functioning as, for example, an IoT sensor for monitoring an equipment state, specifically any one or more of sensors 11 such as a temperature sensor, a humidity sensor, an acceleration sensor, and a noise sensor. In a case where the sensor 11 is the acceleration sensor, the sensor 11 detects, for example, vibration or shaking. The beacon device 10 further has a power storage means that supplies power to a later-described power-reception transmission side MCU 22, such as a secondary battery or a capacitor, for example a chargeable battery 15. Note that power may also be supplied from the battery 15 to the sensor 11 as necessary.

The beacon device 10 further has a directional or non-directional wireless communication antenna (hereinafter referred to as a BLE antenna) 21 forming part of the power-reception transmission side wireless communication unit 20A and allowing the BLE communication, a power-reception transmission side microcontroller unit (MCU) 22 which is a microprocessor-based controller IC integrated with a required input-output interface circuit in addition to an internal memory such as a ROM or a RAM, a wireless power transfer (WPT) power receiver 23 that includes a not-shown built-in power reception circuit resonating with a predetermined reception frequency and a not-shown built-in rectification circuit and rectifies the energy of a received power wave (radio frequency power) into direct-current power and outputs the direct-current power while converting the energy into current, and a diode 24 that allows charging of the battery 15 from the WPT power receiver 23 (power reception circuit) and implements a backflow prevention function during intermittent wireless power transfer described later. Note that the diode 24 is not limited to a diode and any other elements capable of implementing the backflow prevention function can be used instead.

The power-reception transmission side wireless communication unit 20A is a communication module built in the beacon device 10 and having the configuration of a wireless transmitter allowing transmission and reception by the BLE communication via the BLE antenna 21. In addition, the power-reception transmission side wireless communication unit 20A supplies the power received by the WPT power receiver 23 to the power-reception transmission side MCU 22 via the above-described battery 15 to operate the power-reception transmission side MCU 22, and when the power wave transmitted and output from the power-transmission reception apparatus 30 via the power-transmission reception side wireless communication unit 20B is received by a not-shown power reception antenna of the WPT power receiver 23, causes the power-reception transmission side MCU 22 to execute a predetermined determination function according to the presence or absence of power reception or fluctuation in the level of the received power.

FIG. 2 shows functional blocks indicating the functions of the power-reception transmission side MCU 22, and when the power is received by the WPT power receiver 23, the power-reception transmission side MCU 22 executes a power-reception transmission control program saved in advance in the internal memory to implement a plurality of functions 22a to 22d shown in this figure among the functions of a power-reception transmission side controller.

That is, the power-reception transmission side MCU 22 is configured to function as a voltage detector 22a that detects the voltage of the power when the power is received by the WPT power receiver 23 after having been wirelessly transferred, a fluctuation pattern determinator 22b that repeatedly calculates the amount of change in the voltage detected by the voltage detector 22a in every predetermined time and determines, in predetermined determination cycles, whether or not a received-power voltage fluctuation pattern is a fluctuation pattern set and stored in advance in the internal memory, a measurement transmission controller 22c that when it is not determined that a determination result obtained by the fluctuation pattern determinator 22b is the predetermined fluctuation pattern, transmits, as normal operation, information in the form of predetermined data including sensor information via the BLE antenna 21 at preset time or in every lapse of a preset period based on current time or measured elapsed time, and when it is determined that the determination result obtained by the fluctuation pattern determinator 22b is the predetermined fluctuation pattern, opens a reception window of the power-reception transmission side wireless communication unit 20A for a predetermined period such that the power-reception transmission side wireless communication unit 20A is able to receive the BLE communication from the power-transmission reception side wireless communication unit 20B and performs predetermined operation such as an operation of transmitting the information in the form of predetermined data including the sensor information via the BLE antenna 21 at a timing of receiving a command from the power-transmission reception side wireless communication unit 20B by the BLE communication according to the command regardless of the above-described preset time or elapsed time while the reception window is opened, and a sensor information storage 22d that takes an output signal of the sensor 11 in every predetermined time and stores the output signal such that the measurement transmission controller 22c is able to read the output signal.

Note that as the predetermined operation according to the command received from the wireless communication unit 20B by the BLE communication, various settings related to the BLE communication from the power-reception transmission side wireless communication unit 20A can also be changed, for example the setting of the above-described preset time or elapsed time is changed, or firmware can be updated in such a manner that the firmware is received by the power-reception transmission side wireless communication unit 20A by the BLE communication. The predetermined fluctuation pattern described herein is a received-power voltage fluctuation pattern generated when the wireless power transfer from the power-transmission reception apparatus 30 side is intermittently (including a case where a transmission power level fluctuates to a higher or lower level) executed in a predetermined fluctuation pattern, and indicates that the wireless power transfer is performed in the predetermined fluctuation pattern. The fluctuation pattern may also include a case where the received-power voltage fluctuates from a low voltage to a high voltage in response to the start of the wireless power transfer from a state of the wireless power transfer being not performed for certain time.

The power-transmission reception side wireless communication unit 20B is incorporated, for example, into the power-transmission reception apparatus 30, has the configuration of a wireless transmitter allowing BLE reception via a BLE antenna 25, and allows the wireless power transfer (power wave transmission) via a not-shown WPT power transmission antenna of a WPT power transmitter 28.

The power-transmission reception apparatus 30 functions as a host terminal that monitors the state of equipment in which the beacon device 10 is installed based on the sensor information received from the beacon device 10 and provides monitoring information to a higher-level monitoring system, and has a function of supplying the source of the power to be transmitted from the power-transmission reception side wireless communication unit 20B.

The power-reception transmission side MCU 22 further has a function of executing a predetermined information output control program stored and saved in advance in the internal memory (ROM) to generate, in every certain time corresponding to a predetermined standby period (e.g., one day), the sensor information in the form of predetermined data based on the output value (e.g., signal based on detected temperature data in a case where the sensor 11 is the temperature sensor) of the sensor 11 stored in the sensor information storage 22d and transmit and output the sensor information via the BLE antenna 21.

The power-reception transmission side MCU 22 further has a communication control function of generating, based on, e.g., address information, which is identification information on the beacon device 10, and a predetermined transmission condition stored in advance in the internal memory, an advertising packet including the identification information (advertiser's address) on the beacon device 10 and predetermined advertising data having the sensor information in the form of predetermined data based on the output signal of the sensor 11 and transmitting the advertising packet via the BLE antenna 21 of the power-reception transmission side wireless communication unit 20A by, e.g., a frequency hopping method using advertising channels.

Note that the function of generating the sensor information in the form of predetermined data based on the output signal of the sensor 11 is not necessarily executed in the power-reception transmission side MCU 22 alone, but may be executed in another MCU connected to the power-reception transmission side MCU 22. That is, a functional element equivalent to the power-reception transmission side MCU 22 may 22 may be formed by a plurality of MCUs required. In this case, the advertising data generated by another MCU is provided from such a MCU to the power-reception transmission side MCU 22, for example, via a serial communication interface.

The WPT power receiver 23 has a rectifier connected to the power reception antenna, and inputs the power wave emitted from the power-transmission reception side wireless communication unit 20B and received by the power reception antenna to the rectifier to convert the power wave into the direct-current power. Note that the power reception antenna described herein is a not-shown antenna different from the BLE antenna 21 for data transmission, but the emission and reception functions of the BLE antenna 21 may be switchable from each other.

A power reception controller implemented by some of the functions of the power-reception transmission side MCU 22 supplies the received power to the sensor 11 and other loads in the beacon device 10, and executes charge control for the battery 15.

The power-transmission reception side wireless communication unit 20B shown in FIG. 1 includes at least the directional or non-directional BLE antenna 25 and a power-transmission reception side MCU 27 which is a microprocessor-based controller IC integrated with a required input-output interface circuit in addition to an internal memory such as a ROM or a RAM.

The power-transmission reception side wireless communication unit 20B described herein executes a predetermined power-transmission control program saved in the internal memory of the power-transmission reception side MCU 27, thereby functioning as a wireless communication module that receives an RF signal transmitted from the beacon device 10 via the BLE antenna 25 when the beacon device 10 is located relatively close to the power-transmission reception side wireless communication unit 20B and the power-transmission reception side wireless communication unit 20B can receive an RF signal transmitted from any beacon device 10.

The WPT power transmitter 28 is capable of converting the WPT power obtained from a power source provided in the power-transmission reception apparatus 30 into the RF signal having a predetermined frequency and transmitting an electromagnetic wave (power wave) receivable by the beacon device 10 via the not-shown WPT power transmission antenna of the WPT power transmitter 28. The above-described predetermined frequency is selected according to, e.g., a power transmission distance. The power-transmission reception apparatus 30 has, for example, a power conversion circuit that generates direct-current power (Power in FIG. 1) from commercial alternating-current power.

In addition, the power-transmission reception side MCU 27 has the function of a power-transmission reception side controller that changes the wireless power transfer to the beacon device 10 in the predetermined fluctuation pattern such as a predetermined intermittent pattern (ON/OFF pattern; details will be described later). Note that the power-reception transmission side MCU 22 of the beacon device 10 executes the predetermined determination processing to determine whether or not the power received by the WPT power receiver 23 is in the predetermined fluctuation pattern, and according to the determination result, opens the reception window of the power-reception transmission side wireless communication unit 20A for the predetermined period and executes, as the above-described power-reception transmission side controller, the predetermined operation related to sensor information output according to the command received from the power-transmission reception side wireless communication unit 20B while the reception window is opened.

In this case, an operation of the power-transmission reception side MCU 27 changing the wireless power transfer to the beacon device 10 in the predetermined fluctuation pattern results in an operation of generating, for the power-reception transmission side MCU 22, a signal as a trigger for requesting the predetermined operation. When the power wave transmitted from the power-transmission reception apparatus 30 side is received by the WPT power receiver 23, the power-reception transmission side MCU 22 of the power-reception transmission side wireless communication unit 20A implements the function of determining the fluctuation pattern in the wireless power transfer, thereby executing the required predetermined operation after determination of the fluctuation pattern. Thus, using the wireless power transfer itself from the power-transmission reception apparatus 30 side for signal transmission, the beacon device 10 can be activated at arbitrary timing to a state of allowing the predetermined operation related to information output.

As described above, the wireless power-supply communication system 1 of the present embodiment includes the beacon device 10 (information output device) having the WPT power receiver 23 (power reception circuit) that receives the power by the wireless power transfer and the battery 15 (power storage means) chargeable via the power reception circuit and including the built-in power-reception transmission side wireless communication unit 20A that outputs the information in every lapse of the preset standby period, and the power-transmission reception side wireless communication unit 20B (power-transmission reception side device) that is incorporated into or communicably connected to the power-transmission reception apparatus 30 as the host terminal, wirelessly transfers the power to the beacon device 10, and receives the sensor information from the beacon device 10.

The power-transmission reception apparatus 30 or the power-transmission reception side wireless communication unit 20B has the power-transmission reception side MCU 27 (power-transmission reception side controller) that changes the wireless power transfer to the beacon device 10 in the predetermined fluctuation pattern. The power-reception transmission side wireless communication unit 20A built in the beacon device 10 has the power-reception transmission side MCU 22 (power-reception transmission side controller) that determines the fluctuation pattern in the wireless power transfer, and according to the fluctuation pattern determination result, opens the reception window of the power-reception transmission side wireless communication unit 20A for the predetermined period such that the power-reception transmission side wireless communication unit 20A is able to receive the BLE communication from the power-transmission reception side wireless communication unit 20B and executes the predetermined operation related to information transmission, such as an operation of transmitting the information in the form of predetermined data including the sensor information via the BLE antenna 21 or an operation of changing various settings related to the BLE communication from the power-reception transmission side wireless communication unit 20A, according to the command received from the wireless communication unit 20B by the BLE communication while the reception window is opened.

Note that the WPT power transmitter 28 of the power-transmission reception apparatus 30 has the power transmission antenna with non-directional characteristics, and therefore, can transfer the power to a plurality of beacon devices which is present within an area where the wireless power transfer is allowed and is similar to the beacon device 10. One power-transmission reception apparatus 30 can form a wireless power-supply communication system that communicates with a plurality of beacon devices. Note that in this case, a plurality of power-transmission reception side wireless communication units 20B may be provided to perform the BLE communication with the plurality of beacon devices and wirelessly transfer the power to the plurality of beacon devices or a plurality of WPT power transmitters 28 may be provided such that power transmission output equivalent to required power is allowed according to the required power, needless to say.

In the present embodiment, in a normal operation state, the power-reception transmission side MCU 22 executes, until the preset time or during the preset standby period, sleep mode control for bringing at least the power-reception transmission side wireless communication unit 20A into a sleep state or sleep mode control for bringing the entirety of the beacon device 10 including the sensor 11 into a low power consumption state, and in a case where the preset time has come or the preset standby period has elapsed, causes the power-reception transmission side wireless communication unit 20A or the entirety of the beacon device 10 to exit the sleep state in order to communicate advertising (ADV) data in the form of predetermined data including the sensor information from the beacon device 10. After completion of communication of the advertising (ADV) data including the sensor information, the power-reception transmission side MCU 22 executes the above-described sleep mode control again. In this normal operation state, the power may or may not be received by the WPT power receiver 23 by the wireless power transfer. In a case where the power is not received, the power-reception transmission side MCU 22 and the sensor 11 are operated with the power stored in the battery 15. Note that even in a case where the power is received, if the power received by the wireless power transfer is insufficient for operating the power-reception transmission side MCU 22 and the sensor 11, the power is supplied from the battery 15 as necessary.

The sleep mode control described herein is a control mode in which the power-reception transmission side MCU 22 is brought into a standby state with extremely-low power consumption by, e.g., stopping a clock although the power is supplied to the power-reception transmission side MCU 22 or a control mode in which the power-reception transmission side MCU 22 is brought into a standby state with low power consumption to such an extent that a clock for keeping time can be set. Even during the period under the sleep mode control, the power-reception transmission side MCU 22 monitors the state of power reception by the WPT power receiver 23, and when the WPT power receiver 23 of the beacon device 10 starts receiving the power of a predetermined voltage level, executes, e.g., interruption processing for causing the power-reception transmission side wireless communication unit 20A or the entirety of the beacon device 10 to exit the sleep state to end the sleep mode control such that the power-reception transmission side wireless communication unit 20A or the entirety of the beacon device 10 exits the sleep state. With this configuration, the wireless power transfer can be temporarily stopped at arbitrary timing even in a state in which the wireless power transfer from the power-reception transmission side wireless communication unit 20A is performed, and thereafter, the beacon device 10 can exit the sleep state at a timing of resuming the wireless power transfer.

In the present embodiment, the power-reception transmission side wireless communication unit 20A opens the reception window of the power-reception transmission side wireless communication unit 20A with determination on fluctuation in power reception by the WPT power receiver 23 as a trigger while being in the above-described normal operation state, and according to the command received from the power-transmission reception side wireless communication unit 20B by the BLE communication, broadcasts the advertising (ADV) data via the BLE antenna 21 in the form of a BLE packet including a protocol data unit (PDU) of the advertising channel according to the BLE standards in a state in which communication data including the sensor information on the sensor 11, device information on the beacon device 10, and relevant information thereof is incorporated into the PDU of the advertising channel together with specific company identification information. In the present embodiment, this operation is executed in a state of connection by pairing being not established. The power-reception transmission side wireless communication unit 20A can also change various settings related to the BLE communication from the power-reception transmission side wireless communication unit 20A according to the command received from the wireless communication unit 20B by the BLE communication.

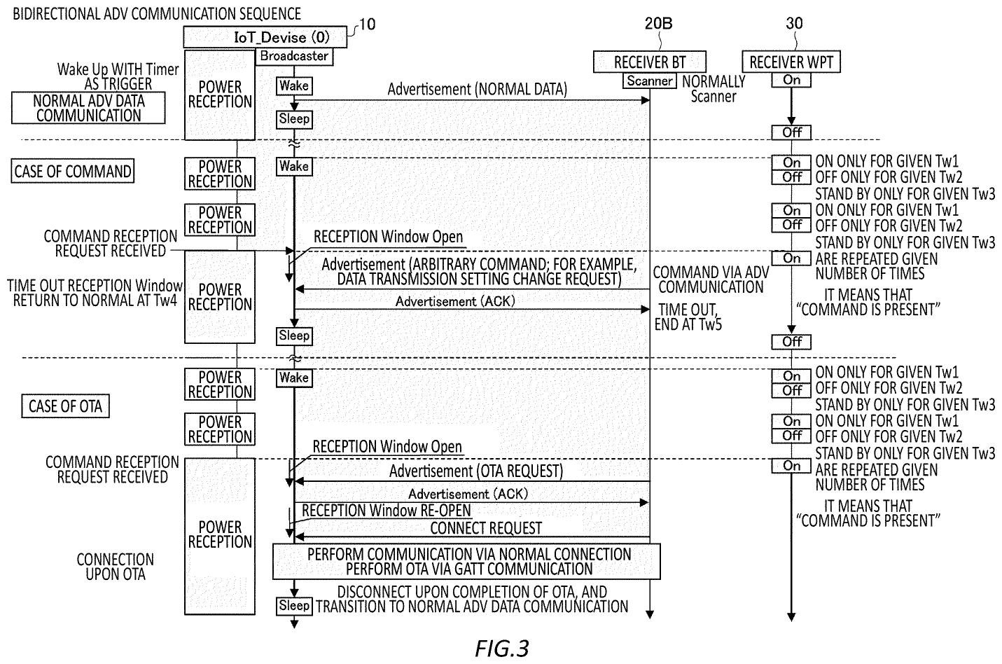

On the other hand, when receiving the advertising communication from the power-reception transmission side wireless communication unit 20A, the power-transmission reception side MCU 27 of the power-reception side wireless communication unit 20B can generate a communication connection response (CONNECT REQUEST in FIG. 3) allowing authentication with a connection partner based on the identification information on the beacon device 10 in the advertising communication, and can establish connection with the power-reception transmission side wireless communication unit 20A by pairing. As one example, predetermined operation not requiring establishment of connection by pairing and predetermined operation requiring connection establishment can be defined, such as an operation of causing the power-reception transmission side MCU 22 of the beacon device 10 to change a condition for the setting related to sensor information transmission or information output at timing other than the preset timing in a state of connection by pairing being not established and causing the power-reception transmission side MCU 22 of the beacon device 10 to update the firmware in a case where connection by pairing has been established. Note that in a case where connection by pairing has been established, the power-reception transmission side MCU 22 of the beacon device 10 may change the condition for the setting related to sensor information transmission or information output at timing other than the preset timing.

Next, operation will be described.

In the wireless power-supply communication system 1 of the present embodiment configured as described above, the beacon device 10 including the built-in power-reception transmission side wireless communication unit 20A outputs, in every lapse of the preset standby period, the sensor information in the form of predetermined data to the power-transmission reception side wireless communication unit 20B incorporated into or communicably connected to the power-transmission reception apparatus 30 side as the host terminal. Meanwhile, the wireless power transfer to the beacon device 10 is performed from the power-transmission reception apparatus 30 side, and the battery 15 in the beacon device 10 is maintained at such a required voltage level that sufficient power can be supplied for operation of the beacon device 10.

When the power-transmission reception side wireless communication unit 20B changes the wireless power transfer in the predetermined fluctuation pattern, the power-reception transmission side wireless communication unit 20A built in the beacon device 10 determines the fluctuation pattern in the wireless power transfer, and according to the fluctuation pattern determination result, opens the reception window of the power-reception transmission side wireless communication unit 20A for the predetermined period and executes the above-described predetermined operation related to, e.g., information transmission according to the command received while the reception window is opened.

According to the determination result, plural different types of communication are selectively executed between the power-reception transmission side wireless communication unit 20A and the power-transmission reception side wireless communication unit 20B and the wireless power transfer and required information communication are executed, as shown in FIG. 3.

Note that FIG. 3 shows, as an example, the outline sequences of three typical types of communication and shows an IoT_Device (0) device equivalent to the beacon device 10 on the left side in the figure, a receiver WPT (WPT power transmitter) included in the power-transmission reception apparatus 30 on the right side in the figure, and a receiver BT equivalent to the power-transmission reception side wireless communication unit 20B incorporated into the power-transmission reception apparatus 30 between the IoT_Device (0) device and the receiver WPT in the figure.

As shown in FIG. 3, in the case of normal advertising (ADV) data communication, the power-reception transmission side MCU 22 is activated with a real time clock (RTC) timer in the power-reception transmission side wireless communication unit 20A, and multi-addresses data in the form of normal data including the sensor information in the non-connection advertising communication packet in the near field communication in accordance with the Bluetooth Low Energy standards, which is the power-saving near field communication. Meanwhile, in the power-transmission reception side wireless communication unit 20B, the power-transmission reception side MCU 27 determines whether or not the received IoT device identification information matches the pre-saved identification information on the beacon device 10, and if matched, the sensor information is acquired as part of the monitoring information on the device side based on the received communication data. After the power-reception transmission side MCU 22 has completed transmission of the data with the sensor information, the beacon device 10 returns to the sleep state, and a control of continuously charging the battery 15 is executed while the WPT power receiver 23 is receiving the power.

As described above, in the present embodiment, the communication data can be transmitted with the sensor information incorporated into the non-connection advertising communication packet before connection by pairing is established between the power-reception transmission side wireless communication unit 20A and the power-transmission reception side wireless communication unit 20B. Thus, it is not necessary to communicate with the host (HOST) side responsible for communication control at certain time intervals in order to maintain a communication connection state after pairing between the beacon device 10, the number of times of transmission of which is small such as once a day, and the power-transmission reception apparatus 30, and power can be saved.

Although such extremely-low power consumption can be achieved, the IoT device such as the beacon device 10 is normally mostly in the sleep state, and has an opportunity to communicate a command only once a day. Even in a case where data is suddenly required or a command needs to be communicated, the command can be received only immediately after the data transmission timing.

However, in the present embodiment, the power-transmission reception side MCU 27 of the power-transmission reception side wireless communication unit 20B can execute, at the time of WPT power transmission, the power-transmission reception side control of changing the wireless power transfer to the beacon device 10 in the predetermined fluctuation pattern, and therefore, implements such a function as necessary to cause the power-reception transmission side MCU 22 to execute the predetermined determination processing. According to the determination result, the power-reception transmission side MCU 22 can open the reception window of the power-reception transmission side wireless communication unit 20A for the predetermined period, and can transmit the information in the form of predetermined data including the sensor information via the BLE antenna 21 at the timing of receiving the command while the reception window is opened.

That is, as shown in the middle in FIG. 3, in a case where a command is sent from the power-transmission reception apparatus 30 side, the power-transmission reception side wireless communication unit 20B is first temporarily stopped, and thereafter, the beacon device 10 exits the sleep state by resumption of the wireless power transfer. Then, the wireless power transfer (WPT power transmission) from the power-transmission reception side wireless communication unit 20B is intermittently performed in the predetermined fluctuation pattern. For example, the WPT power transmission from the power-transmission reception side wireless communication unit 20B is intermittently performed (transmission in a fluctuating pattern) such that the WPT power transmission is performed only for predetermined power transmission time Tw1 (e.g., 0.5 seconds), is interrupted only for predetermined interruption time Tw2 (e.g., 0.5 seconds), is performed again only for the predetermined power transmission time Tw1 after a lapse of predetermined retransmission standby time Tw3, and is interrupted only for the predetermined interruption time Tw2, as shown in FIG. 3.

At this time, on the power-reception transmission side wireless communication unit 20A side, the voltage level of the power received by the WPT power receiver 23 fluctuates in the predetermined fluctuation pattern. In this case, it is determined that the determined result obtained by the fluctuation pattern determinator 22b is the predetermined fluctuation pattern. Accordingly, the power-reception transmission side MCU 22 opens the reception window on the beacon device 10 side for predetermined time Tw4 so that the command can be received on the power-reception transmission side wireless communication unit 20A side.

As shown in the middle in FIG. 3, the command is provided by the advertising (ADV) communication in this case, and before the synchronized communication connection state after pairing, can be transmitted in the form of predetermined advertising packet including the protocol data unit (PDU) of the advertising channel according to the BLE standards in a state in which the advertising data including the specific command, the device information, the communication setting, the firmware update request, and the like is incorporated into the PDU of the advertising channel.

When receiving the command incorporated into the advertising data, the power-reception transmission side MCU 22 changes, for example, the condition (e.g., once a day, once in every several hours, once in every several minutes, or once in every several seconds) for transmission of the data with the sensor information, and thereafter, transmits ACK, which is a response for notifying that the command has been received and recognized, within predetermined time (e.g., several seconds), as the predetermined operation according to the command. When receiving the ACK transmitted from the beacon device 10 within predetermined time Tw5 from transmission of the command, the power-transmission reception side wireless communication unit 20B takes the processing related to the command as normally completed, and ends a series of command transmission processing. In this case, if the time Tw4 has elapsed without the command from the power-transmission reception side wireless communication unit 20B received by the beacon device 10 due to, e.g., a communication error, the power-reception transmission side MCU 22 closes the reception window, and returns to the sleep state. If the time Tw5 has elapsed without the ACK from the beacon device 10 received after transmission of the command, the power-transmission reception side wireless communication unit 20B determines that, e.g., a communication error has been caused, and for example, executes a series of command transmission operation once again.

In this case, the power-reception transmission side MCU 22 also executes the control of continuously charging the battery 15 while the WPT power receiver 23 is receiving the power.

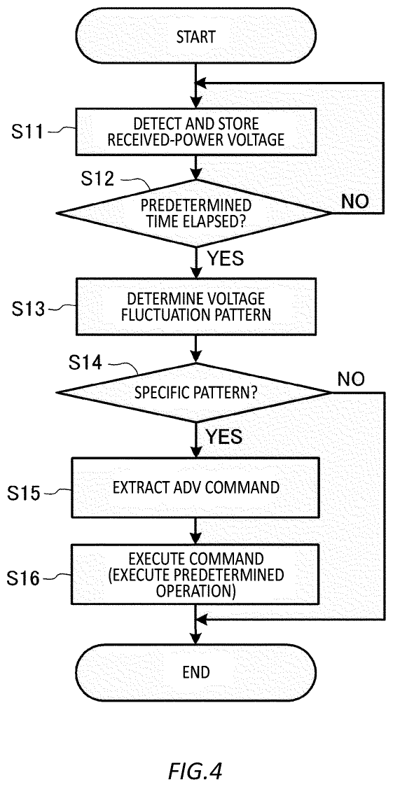

FIG. 4 shows the case of the above-described command as one example, and shows the outline of the flow of processing executed by the power-reception transmission side MCU 22 built in the power-reception transmission side wireless communication unit 20A.

First, in a state in which the WPT power transmission from the power-transmission reception apparatus 30 side is performed and the WPT power receiver 23 receives the power, if the processing shown in FIG. 4 is not executed, the power-reception transmission side MCU 22 is operated within predetermined time and this processing is started.

In this figure, the voltage of the power received by the WPT power receiver 23 and output in the form of direct current is first detected by the voltage detector 22a (Step S11), and until the predetermined time equivalent to the fluctuation pattern determination cycle elapses (until YES in Step S12), voltage detection and storage are repeated (Step S11, S12).

Then, after a lapse of the predetermined time (YES in Step S12), the voltage fluctuation pattern is determined, for example, by comparison between voltage detection data currently detected and stored and a voltage value stored in advance in association with the fluctuation pattern (Step S13).

Subsequently, depending on whether to match the voltage fluctuation pattern with the predetermined fluctuation pattern, the current processing ends if not matched (NO in Step S14). On the other hand, if the voltage fluctuation pattern matches the predetermined fluctuation pattern (YES in Step S14), the reception window of the power-reception transmission side wireless communication unit 20A is subsequently opened for the predetermined period such that the power-reception transmission side wireless communication unit 20A is able to receive the BLE communication from the power-transmission reception side wireless communication unit 20B. In a case where the wireless communication unit 20A receives the advertising (ADV) command while the reception window is opened, the received advertising (ADV) command is extracted (Step S15). After the predetermined operation corresponding to the command has been executed (Step S16), this processing is ended.

Returning to FIG. 3, in a case of Over The Air (OTA) as shown on the lower side in this figure, i.e., in a case where power-saving wireless communication connection to a higher layer is established by pairing and data communication is performed to such an extent that, e.g., the firmware can be updated, the wireless power transfer from the power-reception side wireless communication unit 20B is also first temporarily stopped, and thereafter, the beacon device 10 exits the sleep state by resumption of the wireless power transfer. Then, as in the case of the above-described command, the WPT power transmission from the power-transmission reception side wireless communication unit 20B is intermittently performed in the predetermined fluctuation pattern.

Meanwhile, on the power-reception transmission side wireless communication unit 20A side, the power received by the WPT power receiver 23 fluctuates in the predetermined fluctuation pattern. At this time, it is determined that the determination result obtained by the fluctuation pattern determinator 22b is the predetermined fluctuation pattern. Accordingly, the power-reception transmission side MCU 22 opens the reception window on the beacon device 10 side for the predetermined time Tw4 so that the command can be received on the power-reception transmission side wireless communication unit 20A side.

In the case shown on the lower side in FIG. 3, the command from the power-transmission reception apparatus 30 side is, for example, a firmware update request via OTA, and this case falls into the category of a case where connection needs to be established by pairing in order to update the firmware. In this case, the power-reception transmission side wireless communication unit 20A transmits ACK which is a response for notifying that the power-reception transmission side MCU 22 has received and recognized the command, and waits for a connection request from the power-transmission reception side wireless communication unit 20B before connection by pairing is bidirectionally established.

That is, the power-reception transmission side MCU 22 performs communication via normal connection, such as communication for receiving synchronization processing in accordance with BLE communication regulations, packet transmission timing, frequency channel information for data communication, or the like from the power-transmission reception side wireless communication unit 20B on the master side, thereby, e.g., updating the firmware, as the predetermined operation, via OTA in GATT communication which is the BLE communication after connection establishment. After the predetermined operation, for example, the power-reception transmission side MCU 22 sends data on an updated version (Version) together with ACK for notifying completion of updating, and subsequently, executes the control of returning to the sleep state.

In this case, the power-reception transmission side MCU 22 also executes the control of continuously charging the battery 15 while the WPT power receiver 23 is receiving the power.

As described above, in the present embodiment, the power-transmission reception side MCU 27 changes the WPT power transmission to the beacon device 10 in the predetermined fluctuation pattern, and according to the fluctuation pattern, can transmit the signal requesting the predetermined operation to the beacon device 10. When the power received by the WPT power receiver 23 fluctuates in a specific fluctuation pattern corresponding to the fluctuation pattern in the WPT power transmission, the beacon device 10 causes the power-reception transmission side MCU 22 to implement the fluctuation pattern determination function, thereby determining the predetermined operation required by the fluctuation pattern, such as command reception.

Thus, the wireless power-supply communication system 1 of the present embodiment can activate, using the wireless power transfer itself from the power-transmission reception apparatus 30 side for signal transmission, the beacon device 10 at arbitrary timing and cause the beacon device 10 to execute the predetermined operation related to information output.

In the present embodiment, the power-transmission reception side MCU 27 intermittently performs the WPT power transmission in the predetermined fluctuation pattern, and therefore, the beacon device 10 can be easily brought into a receptable state when the WPT power receiver 23 receives the power in the intermittent pattern.

Moreover, in the present embodiment, the power reception side information output device is the beacon device 10 that transmits the information via the wireless communication in every lapse of the preset standby period, and therefore, the beacon device 10 that performs the power-saving near field communication can be promptly activated as necessary while being used with the power saved because the beacon device 10 can be sufficiently in the standby state.

Further, in the present embodiment, the beacon device 10 has the IoT sensor, and therefore, the sensor information can be promptly output as necessary even if extremely-low power consumption is required and the standby period is long.

In addition, in the present embodiment, the beacon device 10 outputs the information with the output data in the advertising communication packet in the predetermined power-saving near field communication, and therefore, the data can be output from the information output device to the power-transmission reception side device before establishment of intercommunication by pairing and the power required for information output repeated in every lapse of the standby time can be sufficiently reduced.

A wireless power-supply communication method according to an aspect of the present invention is a wireless power-supply communication method including a power storage step of charging the battery 15 via the WPT power receiver 23 receiving the power wave by the wireless power transfer (WPT power transmission) and storing the power in the battery 15, an information output step of outputting, with the stored power, the information from the beacon device 10 in every lapse of the preset standby period, a power supply step of wirelessly transferring the power to the beacon device 10 by the power-transmission reception side wireless communication unit 20B incorporated into or communicably connected to the host terminal, and a reception step of receiving the information output from the beacon device 10 by the power-transmission reception apparatus 30. The wireless power-supply communication method further includes a power transmission control step of fluctuating the WPT power transmission to the beacon device 10 by the power-transmission reception apparatus 30 as the host terminal or the power-transmission reception side wireless communication unit 20B, and an information transmission control step of determining fluctuation in the WPT power transmission by the beacon device 10 and executing the predetermined operation related to information output by the beacon device 10 according to the fluctuation determination result.

Thus, in the wireless power-supply communication method of the present embodiment, in the power supply step from the power-transmission reception apparatus 30 side to the beacon device 10, the signal requesting the predetermined operation according to the fluctuation pattern in the WPT power transmission can be transmitted to the beacon device 10. When the wireless power transfer fluctuates, the beacon device 10 can be activated, and can determine and execute the required predetermined operation with such fluctuation as a trigger. Thus, using the power wave itself transmitted from the power-transmission reception apparatus 30 side by the WPT power transmission, the beacon device 10 can be activated at arbitrary timing, and can execute the predetermined operation related to information output.

As described above, according to the present embodiment, the wireless power-supply communication system 1 can be provided, which is configured so that the beacon device 10 can be activated, using the wireless power transfer from the power-transmission reception apparatus 30 side to the beacon device 10 side, at arbitrary timing even under the sleep state.

Note that in one embodiment described above, the near field communication has been described as the BLE communication, but ZigBee (registered trademark) and other types of power-saving near field communication may be employed.

As described above, an aspect of the present invention can provide a wireless power-supply communication system configured so that a power reception side information output device can be activated, using wireless power transfer itself from a power-transmission reception side device, at arbitrary timing from the power-transmission reception side device. Such an aspect of the present invention is generally useful for a wireless power-supply communication system that receives information output in every lapse of a preset standby period from an information output device by a power-transmission reception side device capable of wirelessly transferring power to the information output device.

### REFERENCE SIGNS LIST

1: Wireless power-supply communication system
10: Beacon device (power reception side information output device, IoT_device)
11: Sensor (temperature sensor, IoT sensor)
15: Battery (power storage means)
20A: Power-reception transmission side wireless communication unit (power-reception transmission side device)
20B: Power-transmission reception side wireless communication unit (power-transmission reception side device, power-transmission receiver BT)
21: BLE antenna (power reception side antenna, transmission side antenna)
22: Microcontroller unit (MCU)
22a: Voltage detector
22b: Fluctuation pattern determinator
22c: Measurement transmission controller
22d: Sensor information storage
23: WPT power receiver (power reception circuit)
24: Diode
25: BLE antenna (reception side antenna, power-transmission side antenna)
27: Power-transmission reception side MCU
30: Power-transmission reception apparatus (power-transmission reception side device, receiver WPT, WPT power transmitter)
Tw1: Predetermined power transmission time
Tw2: Predetermined interruption time
Tw3, Tw4, Tw5: Time

1. A wireless power-supply communication system comprising:
an information output device having a power reception circuit that receives power by wireless power transfer and a power storage means chargeable via the power reception circuit and configured to output information in every lapse of a preset standby period; and
a power-transmission reception side device incorporated into or communicably connected to a host terminal and configured to wirelessly transfer power to the information output device and receive the information from the information output device,
wherein the host terminal or the power-transmission reception side device has a power-transmission reception side controller that fluctuates the wireless power transfer to the information output device, and
the information output device has a power-reception transmission side controller that determines fluctuation in the wireless power transfer and controls the information output device to perform predetermined operation according to a fluctuation determination result.

2. The wireless power-supply communication system according to claim 1, wherein
the power-transmission reception side controller intermittently performs the wireless power transfer from the power-transmission reception side device to the information output device in a predetermined fluctuation pattern.

3. The wireless power-supply communication system according to claim 1, wherein
the power-reception transmission side controller opens a reception window according to the fluctuation determination result, and controls the information output device to perform the predetermined operation according to a command received from the power-transmission reception side device while the reception window is opened.

4. The wireless power-supply communication system according to claim 1, wherein
the information output device is a beacon device that transmits information by wireless communication in every lapse of the preset standby period.

5. The wireless power-supply communication system according to claim 1, wherein
the information output device has an IoT sensor.

6. The wireless power-supply communication system according to claim 4, wherein
the information output device outputs the information with output data in an advertising communication packet in predetermined power-saving near field communication.

7. The wireless power-supply communication system according to claim 2, wherein
the power-reception transmission side controller opens a reception window according to the fluctuation determination result, and controls the information output device to perform the predetermined operation according to a command received from the power-transmission reception side device while the reception window is opened.

8. The wireless power-supply communication system according to claim 2, wherein
the information output device is a beacon device that transmits information by wireless communication in every lapse of the preset standby period.

9. The wireless power-supply communication system according to claim 3, wherein
the information output device is a beacon device that transmits information by wireless communication in every lapse of the preset standby period.

10. The wireless power-supply communication system according to claim 7, wherein
the information output device is a beacon device that transmits information by wireless communication in every lapse of the preset standby period.

11. The wireless power-supply communication system according to claim 2, wherein
the information output device has an IoT sensor.

12. The wireless power-supply communication system according to claim 3, wherein
the information output device has an IoT sensor.

13. The wireless power-supply communication system according to claim 7, wherein
the information output device has an IoT sensor.

14. The wireless power-supply communication system according to claim 4, wherein
the information output device has an IoT sensor.

15. The wireless power-supply communication system according to claim 8, wherein
the information output device has an IoT sensor.

16. The wireless power-supply communication system according to claim 8, wherein
the information output device outputs the information with output data in an advertising communication packet in predetermined power-saving near field communication.

17. The wireless power-supply communication system according to claim 9, wherein
the information output device outputs the information with output data in an advertising communication packet in predetermined power-saving near field communication.

18. The wireless power-supply communication system according to claim 10, wherein
the information output device outputs the information with output data in an advertising communication packet in predetermined power-saving near field communication.

19. The wireless power-supply communication system according to claim 14, wherein
the information output device outputs the information with output data in an advertising communication packet in predetermined power-saving near field communication.

20. A wireless power-supply communication method including a power storage step of storing power in a power storage means via a power reception circuit that receives the power by wireless power transfer, an information output step of outputting, with the stored power, information from a power reception side information output device in every lapse of a preset standby period, a power supply step of wirelessly transferring power to the information output device by a power-transmission reception side device incorporated into or communicably connected to a host terminal, and a reception step of receiving the information output from the information output device by the power-transmission reception side device, further comprising:
a power transmission control step of fluctuating the wireless power transfer to the information output device by the host terminal or the power-transmission reception side device; and
an information transmission control step of determining fluctuation in the wireless power transfer by the information output device and executing predetermined operation related to information output by the information output device according to a fluctuation determination result.
